(19) United States
(12) Patent Application Publication
(10) Pub. No.: US 2007/0028697 A1
(43) Pub. Date: Feb. 8, 2007

(54) One piece needle and diaphragm assembly

(75) Inventor: Stephen R. Shiffer, Xenia, OH (US)

Correspondence Address: Intellectual Property;Honeywell International Inc., 101 Columbia Rd., P.O. Box 2245, Morristown, NJ, 07962, US

(73) Assignee: Honeywell International Inc.

(21) Appl. No.: 11/200,352

(22) Filed: Aug. 8, 2005

(51) Int. Cl. G01L 7/08

(52) U.S. Cl. 73/715

(57) ABSTRACT

A one piece needle and diaphragm system and method configured to measure in-cylinder pressure attributes is disclosed. The pressure monitoring diaphragm can also be configured to slide over the one piece needle and a housing assembly, thus eliminating an additional housing component and a welding operation from the current state of the art. Additionally, the one piece needle and diaphragm system can be used to measure both static and dynamic pressures in various combustion engine applications.

### TECHNICAL FIELD

Embodiments are generally related to the manufacture of in-cylinder pressure sensors, particularly one piece needle and diaphragm systems, and methods. Embodiments are further related to fiber optic dynamic and static pressure measurement systems.

### BACKGROUND

Cylinder pressure is a fundamental factor in determining the operating state of an automotive internal combustions engine. In particular, combustion pressure data can be utilized in advanced engine control and monitoring systems, if available continuously and in real-time. Based on cylinder-specific pressure information, closed-loop control applications have been proposed for power balancing in large-bore natural gas engines, lean burn combustion in passenger cars, or stall control in aircraft engines.

Currently, the widespread use of cylinder pressure based monitoring and control systems has been hampered by one chief factor. The lack of a cost-effective, reliable, and durable combustion pressure sensor has prevented cylinder pressure based detection systems from being widely implemented in commercial and industrial applications.

Piezoelectric-quartz pressure transducers, for example, that have been utilized for decades in engine development and calibration are not well-suited for implementation in production engines. Such devices are subject to electromagnetic interference (EMI) effects, have limited lifetime, and are cost prohibitive. Lower cost piezoceramic devices, for example, such as spark plug washers and boss-type sensors, do not offer high accuracy under all engine conditions, are subject to electrical interference problems, and are prone to large temperature errors. In addition, their durability is not sufficient for use in production engines as a consequence of degrading effects of alloy segregation, selective oxidation, and diffusion.

In contrast to electronic devices, fiber-optic pressure sensors are well suited for applications characterized by high temperatures and high levels of EMI encountered in combustion engines. Such devices, which offer exceptional durability and very low production costs, make fiber optic sensors prime candidates for use in automotive production engines. Due to their miniature size, resistance to high temperatures, and immunity to EMI, such sensors can be combined with existing engine components (e.g., ignition spark plugs, fuel injectors, glow plugs, and so forth).

Such multifunctional devices with embedded pressure sensors can offer numerous advantages for practical and low-cost automotive systems not only from the point of view of sensor expense alone but also on the account of minimum total installation and operational cost. An embedded sensor does not require a separate access point into the engine and the device that the sensor is integrated with can be conventionally installed. No additional cables or connectors are required because the pressure sensor information is sent via the existing cable and connector. Connecting multiple non-embedded sensors to the engine controller represents a complex and costly task in engines with a large number of cylinders.

Referring to FIG. 1, a diagram 100 illustrating an example of prior art sensor configuration is depicted, wherein the needle 110 and needle housing 120 are operatively connected to a diaphragm pressure sensor 130. The diaphragm pressure sensor 130 is welded into place with the needle housing 120. A fiber optic wire 140 is utilized in conjunction with the prior art in-cylinder pressure sensor and is depicted for illustrative purposes only.

The one piece needle and diaphragm assembly provides an alternative to traditional in-cylinder pressure sensing systems, in that they are cheaper to manufacture (e.g. less components by incorporating the needle and housing into one element), require less time to produce by eliminating at least one welding operation, and offer a higher degree of precision which can be more readily tailored to individual customers′needs. In-cylinder pressure sensing allows an unprecedented level of engine performance monitoring, for example, by reducing the total system costs required to achieve stringent new emissions regulations. In addition, fiber optic pressure sensor technology has wide ranging applicability in the civil transportation, aviation, military, and marine industries.

### BRIEF SUMMARY

The following summary is provided to facilitate an understanding of some of the innovative features unique to the present invention and is not intended to be a full description. A full appreciation of the various aspects of the invention can be gained by taking the entire specification, claims, drawings, and abstract as a whole.

According to aspects illustrated herein, there is provided a one piece needle and diaphragm system comprising a pressure monitoring diaphragm functioning as a sensor and a needle and housing assembly operatively connected to said diaphragm sensor.

In accordance with another feature, there is provided a one piece needle and diaphragm pressure measurement system comprising an in-cylinder pressure monitoring diaphragm functioning as a sensor and a fiber optic needle and housing assembly operatively connected to said diaphragm sensor.

Other disclosed features of the embodiments include a method of employing a one piece needle and diaphragm system to measure in-cylinder pressure attributes comprising placing a pressure monitoring diaphragm over a one piece needle and housing assembly and then measuring a specified mechanical distance to collect at least one pressure attribute. Next, the pressure monitoring diaphragm is removably attached to the one piece needle and housing assembly by at least one weld. Finally, the pressure monitoring diaphragm is removed from the one piece needle and housing assembly, thus facilitating serviceability and/or replacement.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a diagram 100 depicted as an example of a prior art sensor configuration for general edification and background purposes;

FIG. 2 illustrates a one piece needle and diaphragm system comprising a pressure monitoring diaphragm functioning as a sensor and a needle and housing assembly operatively connected to the diaphragm sensor which can be implemented in accordance with a preferred embodiment;

FIG. 3 depicts a flow chart illustrating the process employed in using a one piece needle and diaphragm system to measure in-cylinder pressure attributes which can be adapted for use in accordance with a preferred embodiment;

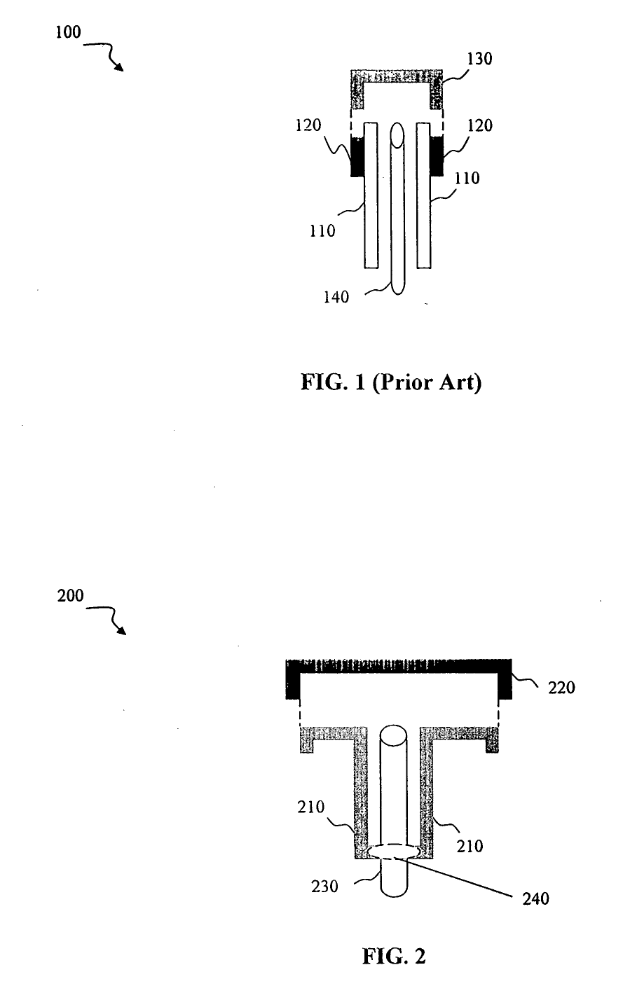

### DETAILED DESCRIPTION OF THE INVENTION

The particular values and configurations discussed in these non-limiting examples can be varied and are cited merely to illustrate at least one embodiment of the present invention and are not intended to limit the scope of the invention.

Referring to FIG. 2, a drawing 200 illustrating a one piece needle and diaphragm system comprising a pressure monitoring diaphragm 220 functioning as a sensor and a needle and housing assembly 210 operatively connected to the diaphragm sensor 220 is depicted, which can be implemented in accordance with a preferred embodiment is shown. The pressure monitoring diaphragm 220 can be placed over the one piece needle and housing assembly 210, which ultimately eliminates an additional component and a welding operation from the prior art sensor configuration. The one piece needle and diaphragm system was engineered to customer-driven specifications. Note that in FIG. 2 identical or similar parts or elements are generally indicated by identical reference numerals.

As further illustrated in FIG. 2, a fiber optic wire 230 can be provided, which is utilized in association with the one piece needle and diaphragm system, in accordance with an embodiment. As the one piece needle and housing assembly are composed of only one element in accordance with an embodiment, an orifice 240 can be provided to allow the fiber optic wire 230 to pass through the sensor housing. Additionally, the geometric shape of the one piece needle and diaphragm system can also be modified or varied.

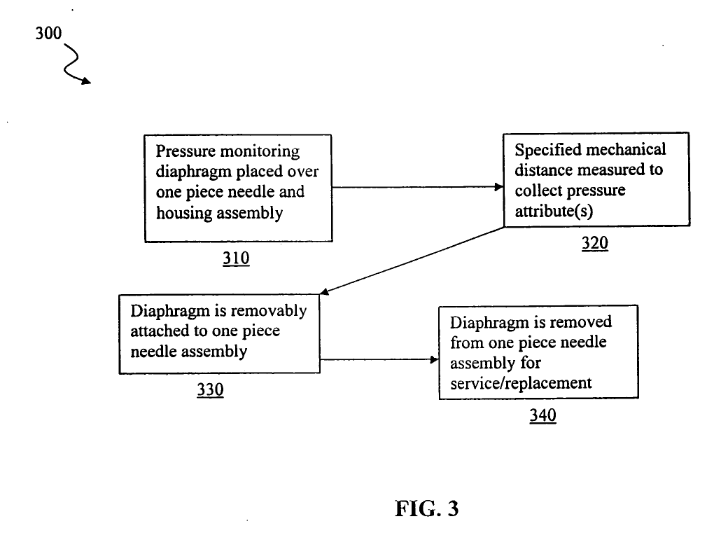

Referring to FIG. 3, a flow chart 300 illustrating the process employed in using a one piece needle and diaphragm system to measure in-cylinder pressure attributes which can be adapted for use in accordance with a preferred embodiment is depicted.

The first step in the employment of a one piece needle and diaphragm system is accomplished by placing a pressure monitoring diaphragm over a one piece needle and housing assembly as depicted in block 310.

Once the pressure monitoring diaphragm is positioned into place, a specified mechanical distance is measured between the one piece needle and housing assembly and the diaphragm as described in block 320. Based on the desired pressure attributes to be collected, this distance can be modified or varied.

After measurement, the pressure monitoring diaphragm is removably attached to the one piece needle and housing assembly by at least one weld as depicted in block 330. Lastly, the pressure monitoring diaphragm can be removed from the one piece needle and housing assembly, thus facilitating serviceability and/or replacement as illustrated in block 340.

It will be appreciated that various of the above disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

The embodiments of the invention in which an exclusive property or right is claimed are defined as follows. Having thus described the invention what is claimed is:

1. A one piece needle and diaphragm system comprising:
a pressure monitoring diaphragm functioning as a sensor; and
a needle and housing assembly operatively connected to said diaphragm sensor.

2. The one piece needle and diaphragm system of claim 1, wherein said pressure monitoring diaphragm is configured as an in-cylinder pressure sensor.

3. The one piece needle and diaphragm system of claim 1, wherein said pressure monitoring diaphragm is welded onto said needle and housing assembly.

4. The one piece needle and diaphragm system of claim 1, wherein said pressure monitoring diaphragm is configured as an in-cylinder, Hall-effect pressure sensor.

5. The one piece needle and diaphragm system of claim 1, wherein said pressure monitoring diaphragm is configured as an in-cylinder, dynamic pressure sensor.

6. The one piece needle and diaphragm system of claim 1, wherein said pressure monitoring diaphragm is configured as an in-cylinder, static pressure sensor.

7. The one piece needle and diaphragm system of claim 1, wherein said pressure monitoring diaphragm is utilized in conjunction with an internal combustion engine.

8. The one piece needle and diaphragm system of claim 1, wherein said pressure monitoring diaphragm is configured to slide over said needle and housing assembly according to a specified mechanical distance.

9. The one piece needle and diaphragm system of claim 8, wherein said pressure monitoring diaphragm is configured as a hat-shaped device.

10. The one piece needle and diaphragm system of claim 1, wherein said pressure monitoring diaphragm is made from a high-strength alloy.

11. A one piece needle and diaphragm pressure measurement system comprising:
an in-cylinder pressure monitoring diaphragm functioning as a sensor; and
a fiber optic needle and housing assembly operatively connected to said diaphragm sensor.

12. The one piece needle and diaphragm pressure measurement system of claim 11, wherein said in-cylinder pressure monitoring diaphragm is removably attached onto said needle and housing assembly by at least one weld.

13. The one piece needle and diaphragm pressure measurement system of claim 11, wherein said in-cylinder pressure monitoring diaphragm is configured as a Hall-effect sensor.

14. The one piece needle and diaphragm pressure measurement system of claim 11, wherein said in-cylinder pressure monitoring diaphragm is configured as a dynamic pressure sensor and wherein said in-cylinder pressure monitoring diaphragm is configured to slide over said needle and housing assembly according to a specified mechanical distance.

15. A method of employing a one piece needle and diaphragm system to measure in-cylinder pressure attributes, comprising
placing a pressure monitoring diaphragm over a one piece needle and housing assembly;
measuring a specified mechanical distance to collect at least one pressure attribute;
removably attaching said pressure monitoring diaphragm to said one piece needle and housing assembly by at least one weld; and
removing said pressure monitoring diaphragm from said one piece needle and housing assembly, thus facilitating serviceability and/or replacement.

16. The method of claim 15 wherein said pressure monitoring diaphragm is configured as a hat-shaped device and wherein said pressure monitoring diaphragm is made from a high-strength alloy.

17. The method of claim 15 wherein said needle and housing assembly utilizes fiber optic wiring.

18. The method of claim 15 wherein said at least one pressure attribute is dynamic pressure.

19. The method of claim 15 wherein said at least one pressure attribute is dynamic pressure.

20. The method of claim 15 wherein said pressure monitoring diaphragm is configured as a Hail-effect sensor.
